(19) United States
(12) Patent Application Publication
(10) Pub. No.: US 2026/0196521 A1
(43) Pub. Date: Jul. 9, 2026

(54) ZINC BATTERY

(71) Applicant: Energywith Co., Ltd., Chiyoda-ku, Tokyo (JP)

(72) Inventor: Kunihiro KUSHIBE, Chiyoda-ku, Tokyo (JP)

(21) Appl. No.: 19/128,180

(22) PCT Filed: Oct. 27, 2023
(86) PCT No.: PCT/JP2023/038972

§ 371 Date: May 8, 2025

(30) Foreign Application Priority Data
Mar. 6, 2023 (JP) 2023-033557

(51) Int. Cl. H01M 4/62; H01M 4/02; H01M 4/48; H01M 10/26

(52) U.S. Cl. CPC H01M 4/628; H01M 4/48; H01M 10/26; H01M 2004/027; H01M 2300/0005

(57) ABSTRACT

A zinc battery having a positive electrode, a negative electrode, and an electrolytic solution, in which the negative electrode has a negative electrode current collector and a negative electrode material supported by the negative electrode current collector, the negative electrode material contains a negative electrode active material and a water-soluble polymer, and the electrolytic solution contains a Lewis acid.

### TECHNICAL FIELD

The present invention relates to a zinc battery.

### BACKGROUND ART

A nickel-zinc battery, an air-zinc battery, a silver-zinc battery, and the like are known as zinc batteries. For example, it is known that, since the nickel-zinc battery is an aqueous battery using an aqueous electrolytic solution such as a potassium hydroxide aqueous solution, the nickel-zinc battery has high safety and also has a high electromotive force as an aqueous battery by a combination of a zinc electrode and a nickel electrode. Further, since the nickel-zinc battery has excellent input/output performance and is also low in cost, applicability to industrial use applications (for example, use applications such as backup batteries), automotive use applications (for example, use applications such as hybrid vehicles), and the like has been studied.

As a negative electrode of a zinc battery, for example, a negative electrode produced using a mixture composition containing zinc oxide, a binder, a conductive auxiliary agent, a water-soluble polymer, and a solvent is known (see, for example, Patent Literature 1).

### CITATION LIST

### Patent Literature

Patent Literature 1: Japanese Unexamined Patent Publication No. 2019-160793

### Non Patent Literature

Non Patent Literature 1: Omameuda Tsutomu, Organic Titanium/Organic Zirconium, Characteristics and Applications of Compounds, Industrial Materials, 2020, Vol. 68 No. 12, pp. 82 to 83

### SUMMARY OF INVENTION

### Technical Problem

Zinc batteries applied to industrial use applications, automotive use applications, and the like are required to have stable battery characteristics that do not depend on an operating environmental temperature as much as possible. For example, it is important to improve cycle characteristics (also referred to as cycle life performance) in a high temperature environment and to improve output characteristics in a low temperature environment.

An object of the present invention is to provide a zinc battery capable of achieving both cycle characteristics in a high temperature environment and output characteristics in a low temperature environment.

### Solution to Problem

The present invention includes the following aspects.
[1] A zinc battery having a positive electrode, a negative electrode, and an electrolytic solution, in which the negative electrode has a negative electrode current collector and a negative electrode material supported by the negative electrode current collector, the negative electrode material contains a negative electrode active material and a water-soluble polymer, and the electrolytic solution contains a Lewis acid.
[2] The zinc battery described in [1], in which the Lewis acid includes a boric acid ion.
[3] The zinc battery described in [1] or [2], in which the Lewis acid includes a polyvalent metal ion.
[4] The zinc battery described in [3], in which the polyvalent metal ion includes at least one metal selected from the group consisting of an aluminum ion, a magnesium ion, a titanium ion, a chromium ion, a manganese ion, an iron ion, a cobalt ion, a nickel ion, a cadmium ion, a lead ion, a calcium ion, and a zirconium ion.
[5] The zinc battery described in any one of [1] to [4], in which the water-soluble polymer includes at least one selected from the group consisting of a polyvinyl-based polymer, a poly(meth)acrylic polymer, and a polysaccharide.
[6] The zinc battery described in [5], in which the water-soluble polymer includes a polyvinyl alcohol.

### Advantageous Effects of Invention

According to the present invention, it is possible to provide a zinc battery capable of achieving both cycle characteristics in a high temperature environment and output characteristics in a low temperature environment.

### DESCRIPTION OF EMBODIMENTS

Hereinafter, embodiments of the present invention will be described in detail. However, the present invention is not limited to the following embodiments, and various modifications can be made within the scope of the gist of the present invention.

In the present specification, a numerical range that has been indicated by use of “to” indicates the range that includes the numerical values which are described before and after “to”, as the minimum value and the maximum value, respectively. In numerical ranges described stepwise in the present specification, the upper limit value or the lower limit value of a numerical range of a certain stage can be arbitrarily combined with the upper limit value or the lower limit value of a numerical range of another stage. In the numerical ranges that are described in the present specification, the upper limit value or the lower limit value of the numerical range may be replaced with the value shown in Examples. “A or B” may include either one of A and B, and may also include both of A and B. Materials listed as examples in the present specification can be used singly or in combinations of two or more kinds, unless otherwise specified. In the present specification, in a case where a plurality of substances corresponding to each component are present in a composition, the used amount of each component in the composition means the total amount of the plurality of substances present in the composition, unless otherwise specified. The term “film” or “layer” in the present specification is meant to include a structure having a shape which is formed over the entire surface when observed in a plan view, as well as a structure having a shape which is formed in a portion. The term “step” in the present specification includes not only an independent step but also a step by which an intended action of the step is achieved, even though the step cannot be clearly distinguished from other steps.

In the present specification, (meth)acryl is a term that encompasses both acryl and methacryl corresponding thereto. The same applies to other similar expressions such as “(meth)acryloyl” and “(meth)acrylate”.

A zinc battery of the present embodiment has at least a positive electrode, a negative electrode, and an electrolytic solution. The negative electrode has a negative electrode current collector and a negative electrode material supported by the negative electrode current collector, and the negative electrode material contains a negative electrode active material and a water-soluble polymer. The electrolytic solution contains a Lewis acid.

According to this zinc battery, it is possible to improve both the cycle characteristics in a high temperature environment (for example, 70° C.) (hereinafter, in some cases, simply referred to as “cycle characteristics”) and the output characteristics in a low temperature environment (for example, −30° C.) (hereinafter, in some cases, simply referred to as “output characteristics”), and to achieve both of these characteristics (according to this zinc battery, in the evaluation method described in Examples described below, the number of cycles of, for example, more than 90 times can be obtained, and direct-current resistance of, for example, less than 12.9 Ω·cm² can be obtained). One of the factors by which such an effect can be obtained is presumed to be the following factors, but is not limited to the following factors.

In the conventional zinc battery, it is known that a dissolution precipitation reaction of zinc ununiformly progresses along with charging and discharging to cause deterioration of the negative electrode such as shape change and internal short-circuit, and battery characteristics are deteriorated. On the other hand, in the zinc battery of the present embodiment, the negative electrode material contains a water-soluble polymer, and the electrolytic solution contains a Lewis acid. It is known that the water-soluble polymer and the Lewis acid react with each other to form a cross-linked structure (for example, Non Patent Literature 1 (Omameuda Tsutomu, Organic Titanium/Organic Zirconium, Characteristics and Applications of Compounds, Industrial Materials, 2020, Vol. 68, No. 12, pp. 82 to 83)). More specifically, for example, compounds such as an organic titanium compound and an organic zirconium compound (compounds containing a Lewis acid) form a cross-linked structure by a covalent bond through a reaction between a metal element of these compounds and a hydrophilic group (a carboxy group, a hydroxyl group, or the like) of a water-soluble polymer. In addition, a compound such as boric acid or sodium borate (a compound containing a Lewis acid) forms a cross-linked structure by hydrogen bonding through a reaction between a boric acid ion and a hydrophilic group (a carboxy group, a hydroxyl group, or the like) of a water-soluble polymer.

In the zinc battery, when the negative electrode material contains a water-soluble polymer and the electrolytic solution contains a Lewis acid, it is considered that the water-soluble polymer and the Lewis acid react to form a cross-linked structure, thereby gelling a portion of the negative electrode material. As a result, it is presumed that the uneven distribution of the electrolytic solution is alleviated, and a local dissolution precipitation reaction associated with dissolution of zinc is suppressed, such that deterioration of the negative electrode such as a shape change and an internal short circuit can be suppressed. In addition, it is considered that a portion of the negative electrode material is gelled, and thus, the amount of electrolytic solution retained in the negative electrode material increases, and it is presumed that the diffusibility of hydroxide ions into the negative electrode material can be improved. It is presumed that the cycle characteristics and the output characteristics are improved with these actions. Conventionally, it has been considered desirable to suppress deterioration such as gelation of the negative electrode material, but the zinc battery of the present embodiment has a feature that cannot be predicted from the conventional zinc battery, in that desired characteristics can be obtained by intentionally gelling a portion of the negative electrode material.

Examples of the zinc battery include a nickel-zinc battery (for example, a nickel-zinc secondary battery) in which the positive electrode is a nickel electrode; an air-zinc battery (for example, an air-zinc secondary battery) in which the positive electrode is an air electrode; and a silver-zinc battery (for example, a silver-zinc secondary battery) in which the positive electrode is a silver oxide electrode.

A zinc battery (for example, a nickel-zinc battery) of the present embodiment has a positive electrode, a negative electrode (zinc negative electrode), an electrolytic solution, and a separator. Such a zinc battery (for example, a nickel-zinc battery) has, for example, a battery container, an electrolytic solution, and an electrode group (for example, an electrode plate group) having a positive electrode, a negative electrode, and a separator. The electrolytic solution and the electrode group are housed in the battery container. The zinc battery (for example, a nickel-zinc battery) may be a battery before or after chemical formation.

In the electrode group, the positive electrode (for example, a positive electrode plate) and the negative electrode (for example, a negative electrode plate) are adjacent to each other with one or a plurality of separators interposed therebetween. That is, one or a plurality of separators are provided between the positive electrode and the negative electrode adjacent to each other. The electrode group may have a plurality of positive electrodes, negative electrodes, and separators. In a case where the electrode group has a plurality of positive electrodes and/or a plurality of negative electrodes, the positive electrodes and the negative electrodes may be alternately laminated with separators interposed therebetween. The plurality of positive electrodes may be connected to each other and the plurality of negative electrodes may be connected to each other, for example, with straps.

The negative electrode has a negative electrode current collector and a negative electrode material supported by the negative electrode current collector, and the negative electrode material contains a negative electrode active material containing zinc and a water-soluble polymer. The negative electrode may be an electrode before or after chemical formation.

The negative electrode current collector constitutes an electrical conducting path for current from the negative electrode material. The negative electrode current collector may have, for example, a flat plate shape, a sheet shape, or the like. The negative electrode current collector may be a current collector having a three-dimensional mesh structure made of foamed metal, expanded metal, perforated metal, metal fiber felt, or the like. The negative electrode current collector may be made of a material having electrical conductivity and alkali resistance. As such a material, for example, materials that are stable even at the reaction potential of the negative electrode (such as a material having a nobler oxidation-reduction potential than the reaction potential of the negative electrode and a material that forms a protective film such as an oxide film on a substrate surface in an alkaline aqueous solution and becomes stabilized) can be used. Furthermore, in the negative electrode, a decomposition reaction of the electrolytic solution progresses as a side reaction to generate hydrogen gas, and a material having a high hydrogen overvoltage is also preferably used from the viewpoint of suppressing the progress of such a side reaction. Specific examples of the material constituting the negative electrode current collector include materials in which at least a part of a surface of a substrate (such as copper, brass, steel, and nickel) is coated by plating with a metal such as zinc, lead, or tin.

More specific examples of the negative electrode current collector whose surface is coated with metal plating include a negative electrode current collector having a substrate and a tin-plated film.

The substrate is made of an electrically conductive material, and preferably contains mainly copper or carbon steel. For example, the substrate may be made of only copper or may be made of only carbon steel. The substrate has a shape such as a flat plate shape. The substrate may be perforated metal made of carbon steel. Carbon steel has conductivity and alkali resistance, and is also stable at the reaction potential of the negative electrode. The substrate may be, for example, a cold-rolled steel sheet or a member obtained by processing a cold-rolled steel sheet. The processing may be, for example, bending processing, pressing processing, and/or drawing processing. For example, a thickness of the substrate may be 0.01 mm or more and may be 0.5 mm or less. The shape of the substrate as viewed from the front may be, for example, various shapes such as a rectangle and a square. For example, an area of the substrate as viewed from the front may be 2000 mm² or more and may be 20000 mm² or less.

The tin-plated film (tin film) covers the whole or a part of the surface of the substrate. When at least a portion of the substrate is covered with the tin-plated film, oxidation of the substrate can be suppressed. In the negative electrode, a decomposition reaction of the electrolytic solution progresses as a side reaction to generate hydrogen gas, but when at least a portion of the substrate is covered with a tin-plated film, the progress of such a side reaction can be suppressed. For example, a thickness of the tin-plated film may be 0.1 μm or more and may be 5 μm or less. When the surface of the substrate is made of copper, the negative electrode current collector may not have a tin-plated film.

The negative electrode current collector may have a plurality of holes penetrating the negative electrode current collector in a thickness direction. In this case, the plurality of holes are two-dimensionally dispersedly arranged according to a certain rule in a plane perpendicular to the thickness direction of the negative electrode current collector. In an example, the plurality of holes are arranged so that centroids coincide with lattice points of a square lattice or a regular triangular lattice. When a tin-plated film is provided on the surface of the substrate, the tin-plated film is also formed inside each of the plurality of holes. In the following description, when a tin-plated film is provided on the surface of the substrate, an inner area and an inner diameter of each of the plurality of holes are defined as follows. That is, the inner area of each of the plurality of holes refers to an inner area of each of the plurality of holes defined by the surface of the tin-plated film formed inside the hole. The inner diameter of each of the plurality of holes refers to an inner diameter of each of the plurality of holes defined by the surface of the tin-plated film formed inside the hole. When a tin-plated film is not provided on the surface of the substrate, an inner area and an inner diameter of each of the plurality of holes are defined as follows. That is, the inner area of each of the plurality of holes refers to an inner area of each of the plurality of holes defined by the surface of the substrate inside the hole. The inner diameter of each of the plurality of holes refers to an inner diameter of each of the plurality of holes defined by the surface of the substrate inside the hole.

When a shape of a cross section (in other words, a cross section parallel to the surface of the negative electrode current collector) perpendicular to the thickness direction of the negative electrode current collector of each of the plurality of holes is a circle having an inner diameter R [mm], the inner area of each of the plurality of holes in the cross section perpendicular to the thickness direction of the negative electrode current collector is calculated as A (R/2) 2 [mm²]. When the inner area of the hole is different depending on the position in the thickness direction of the cross section perpendicular to the thickness direction of the negative electrode current collector, the inner area of the hole is defined by the smallest inner area among them. When the inner diameter of the hole is different depending on the position in the thickness direction of the cross section perpendicular to the thickness direction of the negative electrode current collector, the inner diameter of the hole is defined by the smallest inner diameter among them. The plurality of holes may include one or more holes having an inner area of more than 0.5 mm² and less than 19.6 mm². In other words, the plurality of holes may include one or more holes having an inner diameter R of more than 0.8 mm and less than 5 mm. More preferably, the plurality of holes include one or more holes having an inner area of 1.7 mm² or more and 7.0 mm² or less. In other words, the plurality of holes include one or more holes having an inner diameter R of 1.5 mm or more and 3 mm or less. Further preferably, the plurality of holes include one or more holes having an inner area of 1.7 mm² or more and 3.1 mm² or less. In other words, the plurality of holes include one or more holes having an inner diameter R of 1.5 mm or more and 2 mm or less.

Two or more holes of the plurality of holes may satisfy any numerical ranges among these numerical ranges, and all of the plurality of holes may satisfy any numerical ranges among these numerical ranges. An average value of all the holes may satisfy any numerical ranges among these numerical ranges. A main hole of the plurality of holes may satisfy any numerical ranges among these numerical ranges. The main hole refers to, for example, two or more holes having a uniform size in which a ratio of the holes with respect to an aperture ratio of the negative electrode current collector is 80% or more in total.

The aperture ratio of the negative electrode current collector is defined as a ratio (B/A) between an area A defined by an outer edge of a portion covered with the negative electrode material in the negative electrode current collector and a sum B of inner areas of the plurality of holes. The aperture ratio of the negative electrode current collector is, for example, 35% or more, preferably 40% or more, more preferably 45% or more, and further preferably 50% or more. The aperture ratio of the negative electrode current collector is, for example, 70% or less.

The shape of the cross section perpendicular to the thickness direction of the negative electrode current collector of each of the plurality of holes is not limited to a circle. When the shape of the hole is a quadrangle, the quadrangle includes a square, a rectangle, a parallelogram, a trapezoid, and a rounded quadrangle. When the shape of the hole is a rectangle, a longitudinal direction of the hole may or may not be aligned between the plurality of holes. When the longitudinal direction of the rectangle is aligned between the plurality of holes, the longitudinal direction may be along a vertical direction when the zinc battery is installed, or may be along a horizontal direction. The shape of the hole is not limited to an elliptical shape, and may be, for example, an oval shape. A long axis direction of the elliptical shape or the oval shape may or may not be aligned among the plurality of holes. When the long axis direction of the elliptical shape or the oval shape is aligned between the plurality of holes, the long axis direction may be along a vertical direction when the zinc battery is installed, or may be along a horizontal direction. In a case where the shape of the hole is a polygon, for example, polygons having various numbers of corners such as a triangle, a hexagon, and an octagon can be adopted. The polygon may be a regular polygon.

The negative electrode material may be layered, for example. That is, the negative electrode may have a negative electrode material layer. The negative electrode material layer may be formed on the negative electrode current collector. In a case where a portion of the negative electrode current collector that supports the negative electrode material has a three-dimensional mesh structure, the negative electrode material may be filled between the meshes of the current collector to form a negative electrode material layer.

The negative electrode material contains a negative electrode active material (electrode active material) containing zinc. Examples of the negative electrode active material include metallic zinc, zinc oxide, and zinc hydroxide. The negative electrode active material may contain one kind of these components alone or may contain a plurality of kinds thereof. For example, the negative electrode material contains metallic zinc in a fully charged state and contains zinc oxide and zinc hydroxide in a state of the end of discharge. The negative electrode active material may have, for example, a particulate shape. That is, the negative electrode material may contain at least one selected from the group consisting of metallic zinc particles, zinc oxide particles, and zinc hydroxide particles.

A content of the negative electrode active material is preferably in the following range based on the total mass of the negative electrode material. The content of the negative electrode active material is preferably 50% by mass or more, more preferably 70% by mass or more, further preferably 75% by mass or more, particularly preferably 80% by mass or more, extremely preferably 85% by mass or more, and highly preferably 90% by mass or more, from the viewpoint of easily achieving both excellent cycle characteristics and excellent high-rate discharge performance. The content of the negative electrode active material is preferably 98% by mass or less, more preferably 95% by mass or less, further preferably 93% by mass or less, and particularly preferably 92% by mass or less, from the viewpoint of easily achieving both excellent cycle characteristics and excellent high-rate discharge performance. From these viewpoints, the content of the negative electrode active material is preferably 50 to 98% by mass, and more preferably 50 to 95% by mass.

The negative electrode material of the present embodiment further contains a water-soluble polymer in order to achieve both cycle characteristics in a high temperature environment and output characteristics in a low temperature environment. The water-soluble polymer in the present specification means an organic polymer that can be dissolved in water. The “organic polymer that can be dissolved in water” is defined as a polymer that is dissolved in an amount of 0.1 g or more in 100 g of water (25° C.). The water-soluble polymer may have a hydrophilic group, and examples of the hydrophilic group include a hydroxyl group (hydroxy group), a carboxy group, and an amino group. The water-soluble polymer preferably includes a compound having a hydroxyl group, and more preferably includes a compound having three or more hydroxyl groups, from the viewpoint of further excellent cycle characteristics and output characteristics.

The water-soluble polymer is not particularly limited as long as it is water-soluble, but may include, for example, at least one selected from the group consisting of a polyvinyl-based polymer, a poly(meth)acrylic polymer, and a polysaccharide, from the viewpoint of further excellent cycle characteristics and output characteristics. The water-soluble polymer can also act as a binder in the negative electrode material.

Examples of the polyvinyl-based polymer include a polyvinyl alcohol and polyvinyl pyrrolidone. Examples of the poly(meth)acrylic polymer include poly(meth)acrylic acid and salts (alkali metal salts and the like) of poly(meth)acrylic acid such as sodium poly(meth)acrylate. Examples of the polysaccharide include cellulose-based polymers such as carboxymethyl cellulose (CMC) and salts (alkali metal salts and the like) of carboxymethyl cellulose; alginic acid; alginate such as sodium alginate; and starch or a derivative thereof. The water-soluble polymer preferably includes a polyvinyl-based polymer, and more preferably includes a polyvinyl alcohol, from the viewpoint of further excellent cycle characteristics and output characteristics.

When the negative electrode material contains a polyvinyl alcohol, the polyvinyl alcohol may be a complete or partial saponification product. A saponification degree of a polyvinyl alcohol is preferably 60 mol % or more, 75 mol % or more, 90 mol % or more, 92 mol % or more, 96 mol % or more, 97 mol % or more, or 98 mol % or more, from the viewpoint of easily obtaining excellent life performance and sufficient adhesion of the negative electrode material with respect to the current collector. The saponification degree of the polyvinyl alcohol is preferably 99.9 mol % or less, and more preferably 99 mol % or less, from the viewpoint of easily obtaining excellent life performance and sufficient adhesion of the negative electrode material with respect to the current collector. From these viewpoints, the saponification degree of the polyvinyl alcohol is preferably 60 to 99.9 mol %. Note that the saponification degree of the polyvinyl alcohol is a value measured by a method in accordance with JIS K 6726:1994.

When the negative electrode material contains a polyvinyl alcohol, an average polymerization degree of the polyvinyl alcohol is preferably 250 or more, more preferably 500 or more, and further preferably 800 or more, from the viewpoint of easily obtaining excellent life performance and sufficient adhesion of the negative electrode material with respect to the current collector. The average polymerization degree of the polyvinyl alcohol is preferably 2400 or less, more preferably 1800 or less, and further preferably 1300 or less, from the viewpoint of easily obtaining excellent life performance and sufficient adhesion of the negative electrode material with respect to the current collector. From these viewpoints, the average polymerization degree of the polyvinyl alcohol is preferably 250 to 2400. Note that the average polymerization degree referred to herein is a value measured by a method in accordance with JIS K 6726:1994.

A content of the water-soluble polymer is preferably in the following range based on the total mass of the negative electrode material. A content of the water-soluble polymer is preferably 0.01% by mass or more, 0.05% by mass or more, 0.1% by mass or more, 0.3% by mass or more, 0.5% by mass or more, 0.8% by mass or more, 1.0% by mass or more, 1.5% by mass or more, 2.0% by mass or more, 2.5% by mass or more, or 3.0% by mass or more, from the viewpoint of further excellent cycle characteristics and output characteristics. The content of the water-soluble polymer is preferably 20% by mass or less, 15% by mass or less, 10% by mass or less, 8.0% by mass or less, 6.0% by mass or less, 5.0% by mass or less, 4.0% by mass or less, or 3.0% by mass or less, from the viewpoint of further excellent cycle characteristics and output characteristics. From these viewpoints, the content of the water-soluble polymer is preferably 0.01 to 20% by mass, and more preferably 0.1 to 10% by mass.

The negative electrode material may contain a binder other than the above-described water-soluble polymer as another component. Examples of the binder include polytetrafluoroethylene (PTFE), polyethylene, and polypropylene. A content of the binder may be, for example, 0.5 to 10 parts by mass with respect to 100 parts by mass of the negative electrode active material.

The negative electrode material may further contain an additive such as a dispersant and an electrically conductive agent.

Examples of the dispersant include polymethylsiloxane. A content of the dispersant may be, for example, 0.1 to 1 part by mass with respect to 100 parts by mass of the negative electrode active material.

Examples of the electrically conductive agent include a metal oxide containing at least one metal selected from the group consisting of bismuth (Bi), indium (In), lead (Pb), cadmium (Cd), thallium (Tl), and tin (Sn). A content of the electrically conductive agent may be 1 to 50% by mass based on the total mass of the negative electrode material.

A thickness of the negative electrode is preferably 0.3 to 0.5 mm from the viewpoint of easily achieving both excellent cycle characteristics and excellent high-rate discharge performance. Here, the thickness of the negative electrode means the total thickness (thickness (for example, the thickness of the negative electrode material layer) after the current collector is filled with the negative electrode material and pressed to a predetermined density using a roller or the like) of the negative electrode.

The positive electrode has, for example, a positive electrode current collector and a positive electrode material supported by the positive electrode current collector. The positive electrode may be an electrode before or after chemical formation.

The positive electrode current collector constitutes an electrical conducting path for current from the positive electrode material. The positive electrode current collector may have, for example, a flat plate shape, a sheet shape, or the like. The positive electrode current collector may be a current collector having a three-dimensional mesh structure made of foamed metal, expanded metal, perforated metal, metal fiber felt, or the like. The positive electrode current collector is made of a material having electrical conductivity and alkali resistance.

As such a material, for example, materials that are stable even at the reaction potential of the positive electrode (such as a material having a nobler oxidation-reduction potential than the reaction potential of the positive electrode and a material that forms a protective film such as an oxide film on a substrate surface in an alkaline aqueous solution and becomes stabilized) can be used. Furthermore, in the positive electrode, a decomposition reaction of the electrolytic solution progresses as a side reaction to generate oxygen gas, and a material having a high oxygen overvoltage is also preferably used from the viewpoint of suppressing the progress of such a side reaction. Specific examples of the material constituting the positive electrode current collector include platinum; nickel (such as foamed nickel); and metal materials (such as copper, brass, and steel) plated with metal such as nickel. Among these, a positive electrode current collector made of foamed nickel is preferably used. From the viewpoint that high-rate discharge performance can be further improved, it is preferable that at least a portion (positive electrode material supporting portion) supporting the positive electrode material in the positive electrode current collector is made of foamed nickel.

The positive electrode material may be layered, for example. That is, the positive electrode may have a positive electrode material layer. The positive electrode material layer may be formed on the positive electrode current collector. In a case where a positive electrode material supporting portion of the positive electrode current collector has a three-dimensional mesh structure, the positive electrode material may be filled between the meshes of the current collector to form a positive electrode material layer. For example, the positive electrode material contains a positive electrode active material (electrode active material) containing nickel in a nickel-zinc battery. Examples of the positive electrode active material include nickel oxyhydroxide (NiOOH) and nickel hydroxide. For example, the positive electrode material contains nickel oxyhydroxide in a fully charged state and contains nickel hydroxide in a state of the end of discharge. The content of the positive electrode active material may be, for example, 50 to 95% by mass based on the total mass of the positive electrode material.

The positive electrode material may further contain, as an additive, a component other than the positive electrode active material. Examples of the additive include a binder, an electrically conductive agent, and an expansion inhibitor.

Examples of the binder include hydrophilic or hydrophobic polymers. Specifically, for example, carboxymethyl cellulose (CMC), hydroxyethyl cellulose (HEC), hydroxypropyl methylcellulose (HPMC), sodium polyacrylate (SPA), a fluorine-based polymer (such as polytetrafluoroethylene (PTFE)), and the like can be used as the binder. The content of the binder is preferably, for example, 0.01 to 5 parts by mass with respect to 100 parts by mass of the positive electrode active material.

Examples of the electrically conductive agent include a cobalt compound (metal cobalt, cobalt oxide, cobalt hydroxide, and the like). A content of the electrically conductive agent is preferably, for example, 1 to 20 parts by mass with respect to 100 parts by mass of the positive electrode active material.

Examples of the expansion inhibitor include zinc oxide. A content of the expansion inhibitor is preferably, for example, 0.01 to 5 parts by mass with respect to 100 parts by mass of the positive electrode active material.

The electrolytic solution contains a component for imparting electrical conductivity, a Lewis acid, and a solvent. The solvent may be water (for example, ion-exchange water).

Examples of the component for imparting electrical conductivity include an alkali metal hydroxide. Examples of the alkali metal hydroxide include potassium hydroxide (KOH), sodium hydroxide (NaOH), and lithium hydroxide (LiOH). The alkali metal hydroxide may be ionized (dissociated) in an electrolytic solution (for example, an aqueous solution) and may be present as a salt. The electrolytic solution may contain hydroxide ions and may contain alkali metal ions. The alkali metal hydroxide preferably includes at least one selected from the group consisting of potassium hydroxide and lithium hydroxide and more preferably includes potassium hydroxide, from the viewpoint of easily suppressing a decrease in discharge capacity when the zinc battery is stored and the viewpoint of easily obtaining excellent high-rate discharge performance.

A content of the component for imparting electrical conductivity is preferably in the following range based on the total mass of the electrolytic solution from the viewpoint of easily suppressing a decrease in discharge capacity when the zinc battery is stored and from the viewpoint of easily obtaining excellent high-rate discharge performance. The content of the component for imparting electrical conductivity is preferably 10% by mass or more, 15% by mass or more, 20% by mass or more, 25% by mass or more, or 30% by mass or more. The content of the component for imparting electrical conductivity is preferably 50% by mass or less, 45% by mass or less, 40% by mass or less, or 35% by mass or less. From these viewpoints, the content of the component for imparting electrical conductivity is preferably 10 to 50% by mass.

The electrolytic solution of the present embodiment contains a Lewis acid in order to achieve both cycle characteristics in a high temperature environment and output characteristics in a low temperature environment. The Lewis acid preferably includes an ion different from the alkali metal ion, and more preferably includes at least one selected from the group consisting of a boric acid ion and a polyvalent metal ion, from the viewpoint of further excellent cycle characteristics and the output characteristics. The Lewis acid may include a boric acid ion and may include a polyvalent metal ion, from the viewpoint of further excellent cycle characteristics and the output characteristics.

In one embodiment, the Lewis acid is a boric acid ion. The boric acid ion contained in the electrolytic solution may be a boric acid ion derived from a compound containing a boric acid ion (hereinafter, also referred to as a boric acid compound). The boric acid compound may be ionized (dissociated) in the electrolytic solution and may not be ionized (dissociated) in the electrolytic solution. The boric acid compound is preferably at least one selected from the group consisting of boric acid and borate. Examples of the borate include alkali metal borate (sodium borate, potassium borate, and the like) and zinc borate. The electrolytic solution preferably contains a boric acid compound, more preferably contains at least one selected from the group consisting of boric acid and a borate, further preferably contains at least one selected from the group consisting of boric acid and an alkali metal borate, and particularly preferably contains at least one selected from the group consisting of boric acid and sodium borate, from the viewpoint of further excellent cycle characteristics and the output characteristics.

A content of the boric acid compound added to the electrolytic solution is preferably in the following range based on the total mass of the electrolytic solution. The content of the boric acid compound is preferably 0.05% by mass or more, more preferably 0.1% by mass or more, further preferably 0.3% by mass or more, particularly preferably 0.5% by mass or more, extremely preferably 0.8% by mass or more, and highly preferably 1% by mass or more, from the viewpoint of further excellent cycle characteristics in a high temperature environment and output characteristics in a low temperature environment. The content of the boric acid compound is preferably 30% by mass or less, more preferably 20% by mass or less, further preferably 10% by mass or less, particularly preferably 8% by mass or less, extremely preferably 5% by mass or less, highly preferably 3% by mass or less, and even more preferably 1% by mass or less, from the viewpoint of further excellent cycle characteristics in a high temperature environment and output characteristics in a low temperature environment. From these viewpoints, the content of the boric acid compound is preferably 0.05 to 30% by mass.

In another embodiment, the Lewis acid is a polyvalent metal ion. In the present specification, the polyvalent metal ion is a divalent or higher metal ion. The polyvalent metal ion preferably includes at least one selected from the group consisting of an aluminum ion, a magnesium ion, a titanium ion, a chromium ion, a manganese ion, an iron ion, a cobalt ion, a nickel ion, a cadmium ion, a lead ion, a calcium ion, and a zirconium ion, and more preferably includes a titanium ion, from the viewpoint of further excellent cycle characteristics and output characteristics.

The polyvalent metal ion contained in the electrolytic solution may be a polyvalent metal ion derived from a compound containing a polyvalent metal ion (hereinafter, also referred to as a polyvalent metal compound). The polyvalent metal compound may be ionized (dissociated) in the electrolytic solution and may not be ionized (dissociated) in the electrolytic solution. The polyvalent metal compound may be a polyvalent metal hydroxide, a polyvalent metal oxide, a polyvalent metal inorganic salt, a polyvalent metal organic salt, or the like. More specifically, examples of the polyvalent metal hydroxide include aluminum hydroxide, calcium hydroxide, magnesium hydroxide, and magnesium aluminum hydroxide. Examples of the polyvalent metal oxide include aluminum oxide, calcium oxide, magnesium oxide, and sodium aluminate. Examples of the polyvalent metal inorganic salt include aluminum sulfate, aluminum potassium sulfate, aluminum ammonium sulfate, aluminum carbonate, aluminum nitrate, aluminum chloride, calcium sulfate, calcium carbonate, calcium chloride, magnesium sulfate, magnesium carbonate, magnesium chloride, magnesium aluminosilicate (meta) silicate, and synthetic hydrotalcite. Examples of the polyvalent metal organic salt include aluminum acetate; calcium acetate; magnesium acetate; aluminum lactate; aluminum stearate; aluminum myristate; alkaline earth metal salts such as aluminum glycinate, aluminum benzoate, aluminium chlorohydroxy allantoinate, calcium salt or magnesium salt of thioglycolic acid, and titanium chelate compounds such as titanium lactate and titanium triethanolaminate; and zirconium chelate compounds coordinated with an oxycarboxylic acid or triethanolamine, such as zirconium lactate ammonium salts. From the viewpoint of further excellent cycle characteristics and the output characteristics, the electrolytic solution preferably contains a polyvalent metal compound, more preferably contains a titanium chelate compound, and further preferably contains at least one selected from the group consisting of titanium lactate and titanium triethanolaminate.

A content of the polyvalent metal compound added to the electrolytic solution is preferably in the following range based on the total mass of the electrolytic solution. The content of the polyvalent metal compound is preferably 0.05% by mass or more, more preferably 0.1% by mass or more, further preferably 0.3% by mass or more, particularly preferably 0.5% by mass or more, extremely preferably 0.8% by mass or more, and highly preferably 1% by mass or more, from the viewpoint of further excellent cycle characteristics in a high temperature environment and output characteristics in a low temperature environment. The content of the polyvalent metal compound is preferably 30% by mass or less, more preferably 20% by mass or less, further preferably 10% by mass or less, particularly preferably 8% by mass or less, extremely preferably 5% by mass or less, highly preferably 3% by mass or less, and even more preferably 1% by mass or less, from the viewpoint of further excellent cycle characteristics in a high temperature environment and output characteristics in a low temperature environment. From these viewpoints, the content of the polyvalent metal compound is preferably 0.05 to 30% by mass.

The electrolytic solution may further contain a surfactant, a saccharide, and the like.

Examples of the surfactant include didodecyldimethylammonium bromide, tetradecyltrimethylammonium bromide, polyoxyethylene decyl ether, and polyoxyalkylene alkyl ether phosphate. The surfactant preferably includes tetradecyltrimethylammonium bromide from the viewpoint of easily obtaining excellent cycle characteristics and the viewpoint of easily suppressing a decrease in discharge capacity.

A content of the surfactant is preferably in the following range based on the total mass of the electrolytic solution. The content of the surfactant is preferably 0.001% by mass or more, 0.003% by mass or more, 0.005% by mass or more, or 0.01% by mass or more, from the viewpoint of easily suppressing the deterioration of the discharge performance of the zinc battery. The content of the surfactant is preferably 5% by mass or less, 2.5% by mass or less, 1% by mass or less, 0.7% by mass or less, or 0.5% by mass or less, from the viewpoint of easily obtaining excellent cycle characteristics and the viewpoint of easily suppressing a decrease in discharge capacity. From these viewpoints, the content of the surfactant is preferably 0.001 to 5% by mass.

As the saccharide, monosaccharides, disaccharides, trisaccharides, polysaccharides (excluding saccharides corresponding to disaccharides or trisaccharides), and the like can be used. Examples of the monosaccharide include glucose, fructose, galactose, arabinose, ribose, mannose, xylose, sorbose, rhamnose, fucose, ribodesose, and hydrates thereof. Examples of the disaccharide include sucrose, maltose, trehalose, cellobiose, gentiobiose, lactose, melibiose, and hydrates thereof. Examples of the trisaccharide include kestose, melezitose, gentianose, raffinose, and hydrates thereof. Examples of the polysaccharide include cyclodextrin (for example, γ-cyclodextrin) and stachyose.

A content of the saccharide is preferably in the following range based on the total mass of the electrolytic solution. The content of the saccharide is preferably 0.1% by mass or more, 0.3% by mass or more, 0.5% by mass or more, 0.8% by mass or more, or 1% by mass or more, from the viewpoint of easily suppressing a decrease in discharge capacity when the zinc battery is stored and the viewpoint of easily obtaining excellent high-rate discharge performance. The content of the saccharide is preferably 5% by mass or less, 4.5% by mass or less, 4% by mass or less, 3.5% by mass or less, or 3% by mass or less, from the viewpoint of easily suppressing a decrease in discharge capacity when the zinc battery is stored and the viewpoint of easily obtaining excellent high-rate discharge performance. From these viewpoints, the content of the saccharide is preferably 0.1 to 5% by mass.

The separator may be, for example, a separator having a flat plate shape, a sheet shape, or the like. Examples of the separator include a polyolefin-based porous membrane (also referred to as a microporous membrane), a nylon-based porous membrane, an oxidation-resistant ion-exchange resin membrane, a cellophane-based recycled resin membrane, an inorganic-organic separator, and a polyolefin-based nonwoven fabric. The separator may be processed into a bag shape so as to house the positive electrode and/or the negative electrode. In this case, the positive electrode and/or the negative electrode may be housed in the separator. The separators may be used singly or in combinations of two or more kinds.

Subsequently, a method for manufacturing the zinc battery (for example, the nickel-zinc battery) described above will be described. The method for manufacturing the zinc battery (for example, the nickel-zinc battery) of the present embodiment includes, for example, a constituent member manufacturing step of obtaining constituent members of a zinc battery (for example, a nickel-zinc battery), and an assembling step of assembling the constituent members to obtain a zinc battery. In the constituent member manufacturing step, at least electrodes (a positive electrode and a negative electrode) are obtained.

The electrode can be obtained, for example, by adding a solvent (for example, water) to raw materials for electrode materials (a positive electrode material and a negative electrode material) and kneading to obtain an electrode material paste (paste-like electrode material), and then filling the electrode material paste in a current collector to form an electrode material layer.

Examples of the raw material for the positive electrode material include raw materials for a positive electrode active material (for example, nickel hydroxide) and additives. Examples of the raw material for the negative electrode material include raw materials for a negative electrode active material (for example, metallic zinc, zinc oxide, and zinc hydroxide), the above-described water-soluble polymer, and additives.

Examples of the method for forming an electrode material layer include a method of applying or filling an electrode material paste to or in a current collector and then drying the electrode material paste to obtain an electrode material layer. The density of the electrode material layer may be increased by pressing using a roller, or the like, if necessary.

In the assembling step, for example, the positive electrodes and the negative electrodes obtained in the constituent member manufacturing step are alternately laminated with a separator interposed therebetween, and then the positive electrodes are connected to each other and the negative electrodes are connected to each other with straps to form an electrode group. Next, after this electrode group is disposed in a battery container, a cover is attached to the upper surface of the battery container to obtain a chemically unformed zinc battery (for example, a nickel-zinc battery).

Subsequently, the electrolytic solution is injected into the battery container of the chemically unformed zinc battery, and then left for a certain period of time. Next, chemical formation is performed by performing charging under predetermined conditions to obtain a zinc battery (for example, a nickel-zinc battery). The chemical formation conditions can be adjusted according to the properties of the electrode active materials (the positive electrode active material and the negative electrode active material). For example, a zinc battery (for example, a nickel-zinc battery) after chemical formation can be produced by performing charging under conditions of an atmospheric temperature of 25° C., 32 mA, and 12 hours.

In the above description, for the positive electrode material, the example of the nickel-zinc battery (for example, a nickel-zinc secondary battery) in which the positive electrode is a nickel electrode has been described, but the zinc battery may be an air-zinc battery (for example, an air-zinc secondary battery) in which the positive electrode is an air electrode, and may be a silver-zinc battery (for example, a silver-zinc secondary battery) in which the positive electrode is a silver oxide electrode.

As the air electrode of the air-zinc battery, a known air electrode used in the air-zinc battery can be used. The air electrode contains, for example, an air electrode catalyst, an electron-conductive material, and the like. As the air electrode catalyst, an air electrode catalyst also functioning as an electron-conductive material can be used.

As the air electrode catalyst, a catalyst functioning as a positive electrode in an air-zinc battery can be used, and various air electrode catalysts that can use oxygen as a positive electrode active material can be used. Examples of the air electrode catalyst include carbon-based materials having an oxidation-reduction catalyst function (such as graphite), metal materials having an oxidation-reduction catalyst function (such as platinum and nickel), and inorganic oxide materials having an oxidation-reduction catalyst function (such as perovskite-type oxide, manganese dioxide, nickel oxide, cobalt oxide, and spinel oxide). The shape of the air electrode catalyst is not particularly limited, and may be, for example, a particulate shape. The used amount of the air electrode catalyst in the air electrode may be 5 to 70% by volume, may be 5 to 60% by volume, and may be 5 to 50% by volume, with respect to the total volume of the air electrode.

As the electron-conductive material, a material having electrical conductivity and enabling electronic conduction between the air electrode catalyst and the separator can be used. Examples of the electron-conductive material include carbon blacks such as ketjen black, acetylene black, channel black, furnace black, lamp black, and thermal black; graphites such as natural graphite like flake graphite, artificial graphite, and expanded graphite; conductive fibers such as carbon fibers and metal fibers; powders of metals such as copper, silver, nickel, and aluminum; organic electron-conductive materials such as a polyphenylene derivative; and any mixtures of these materials. The shape of the electron-conductive material may be a particulate shape, and may be other shapes. The electron-conductive material is preferably used in the form that provides a continuous phase in a thickness direction in the air electrode. For example, the electron-conductive material may be a porous material. Furthermore, the electron-conductive material may be in the form of a mixture or composite with the air electrode catalyst, and as described above, may be an air electrode catalyst also functioning as an electron-conductive material. The used amount of the electron-conductive material in the air electrode may be 10 to 80% by volume, may be 15 to 80% by volume, and may be 20 to 80% by volume, with respect to the total volume of the air electrode.

As the silver oxide electrode of the silver-zinc battery, a known silver oxide electrode used in the silver-zinc battery can be used. The silver oxide electrode contains, for example, silver (I) oxide.

### EXAMPLES

Hereinafter, the present invention will be specifically described with reference to Examples. However, the present invention is not limited to the following Examples.

### Example 1

### <Production of Negative Electrode>

As a negative electrode current collector, a tin-plated steel plate perforated metal having a porosity of 50% was prepared. Next, predetermined amounts of zinc oxide (manufactured by MITSUI MINING & SMELTING CO., LTD., general product), metallic zinc (manufactured by MITSUI MINING & SMELTING CO., LTD., MA-ZB (trade name)), a polyvinyl alcohol (PVA, saponification degree: 99 mol %, manufactured by Kuraray Co., Ltd., POVAL 60-98 (trade name)), PTFE dispersion (manufactured by Daikin Industries, Ltd., D-210C (trade name)), bismuth oxide (manufactured by COREFRONT Corporation, 1710CY (trade name)), and ion-exchange water were mixed and then kneaded to produce a negative electrode material paste. At this time, a solid mass ratio was adjusted to “zinc oxide:metallic zinc:PVA:PTFE:bismuth oxide=75:16:3:1:5”. The amount of water in the negative electrode material paste was adjusted to 20% by mass based on the total mass of the negative electrode material paste. Next, the negative electrode material paste was applied to the negative electrode current collector, and then dried at 80° C. for 30 minutes. Thereafter, pressure molding was performed by a roll press to obtain a chemically unformed negative electrode having a negative electrode material (negative electrode material layer). A content of PVA (water-soluble polymer) was 1% by mass based on the total mass of the negative electrode material.

### <Production of Positive Electrode>

A grid body made of foamed nickel having a porosity of 95% was prepared, and the grid body was pressure-molded to obtain a positive electrode current collector. Next, predetermined amounts of cobalt-coated nickel hydroxide powder (manufactured by Gold Shine Energy Material Co., Ltd., Y6 (trade name)), metallic cobalt (manufactured by Nikkoshi Co., Ltd., EXTRA FINE (trade name)), cobalt hydroxide (manufactured by ISE CHEMICALS CORPORATION), yttrium oxide (manufactured by FUJIFILM Wako Pure Chemical Corporation, special reagent grade), carboxymethyl cellulose (CMC, manufactured by Changshu Wealthy Science and Technology Co., ltd., BH90-3 (trade name)), polytetrafluoroethylene (PTFE, manufactured by Daikin Industries, Ltd., D210-C(trade name)), and ion-exchange water were mixed and then kneaded to produce a positive electrode material paste. At this time, the solid mass ratio was adjusted to “nickel hydroxide:metallic cobalt:yttrium oxide:cobalt hydroxide:CMC:PTFE=88.0:10.3:1.0:0.3:0.3:0.1”. The amount of water in the positive electrode material paste was adjusted to 27.5% by mass based on the total mass of the positive electrode material paste. Next, the positive electrode material paste was applied to the positive electrode material supporting portion of the positive electrode current collector, and then dried at 80° C. for 30 minutes. Thereafter, pressure molding was performed using a roll press to obtain a chemically unformed positive electrode having a positive electrode material layer.

### <Preparation of Separator>

For the separator, UP3355 (manufactured by Ube Industries, Ltd., trade name, air permeability: 440 sec/100 mL) was used as a porous membrane, and a nonwoven fabric (manufactured by NIPPON KODOSHI CORPORATION, trade name: VL-100, air permeability: 0.3 sec/100 mL) was used as a nonwoven fabric. The porous membrane was subjected to hydrophilization treatment with a surfactant Triton-X100 (manufactured by Sigma-Aldrich Japan G.K., trade name) before assembling of a battery. The hydrophilization treatment was performed by a method of immersing the porous membrane in an aqueous solution containing Triton-X100 in an amount of 1% by mass for 24 hours, and then performing drying at room temperature (25° C.) for 1 hour. Note that, the air permeability of the porous membrane indicates a value after the hydrophilization treatment. Further, the porous membrane was cut into a predetermined size, folded in half, and processed into a bag shape by heat-sealing side surfaces with using the folded part as a bottom. The nonwoven fabric cut into a predetermined size was used. Note that, the air permeability described herein is a value as measured by the method according to JIS P 8117:2009.

### <Preparation of Electrolytic Solution>

Ion-exchange water, potassium hydroxide (KOH), lithium hydroxide (LiOH), and boric acid were mixed to prepare an electrolytic solution (with respect to the total mass of the electrolytic solution, potassium hydroxide: 25.0% by mass, lithium hydroxide: 1.0% by mass, boric acid: 1.0% by mass, and ion-exchange water: 73.0% by mass).

### <Production of Nickel-Zinc Battery>

One positive electrode (chemically unformed positive electrode) and one negative electrode (chemically unformed negative electrode) were respectively housed in each porous membrane processed into a bag shape. The positive electrode housed in the bag-shaped porous membrane, the negative electrode housed in the bag-shaped porous membrane, and the nonwoven fabric were laminated, and then the electrode plates of the same polarity were connected to each other with straps to produce an electrode group (electrode plate group). The electrode group had a configuration in which two positive electrodes and three negative electrodes were included and the nonwoven fabric was disposed one by one between the positive electrode and the negative electrode (between the porous membrane on the positive electrode side and the porous membrane on the negative electrode side). After this electrode group was disposed in a battery container, a cover was attached to the upper surface of the battery container, and the above-described electrolytic solution was poured into the battery container, thereby obtaining a chemically unformed nickel-zinc battery. Thereafter, a nickel-zinc battery having a nominal capacity of 320 mAh was produced by charging under the conditions of an ambient temperature of 25° C., 32 mA, and 12 hours.

### Example 2

A nickel-zinc battery was produced in the same manner as in Example 1, except that sodium borate was used instead of boric acid in the preparation of the electrolytic solution in Example 1. The content of sodium borate was 1.0% by mass with respect to the total mass of the electrolytic solution.

### Example 3

A nickel-zinc battery was produced in the same manner as in Example 1, except that titanium lactate was used instead of boric acid in the preparation of the electrolytic solution in Example 1. The content of titanium lactate was 1.0% by mass with respect to the total mass of the electrolytic solution.

### Example 4

A nickel-zinc battery was produced in the same manner as in Example 1, except that titanium triethanolaminate was used instead of boric acid in the preparation of the electrolytic solution in Example 1. The content of titanium triethanolaminate was 1.0% by mass with respect to the total mass of the electrolytic solution.

### Comparative Example 1

A zinc battery was produced in the same manner as in Example 1, except that the amount of ion-exchange water was changed to 74.0% by mass without adding boric acid in the preparation of the electrolytic solution in Example 1.

### <Evaluation of Cycle Characteristics>

The cycle characteristics of the nickel-zinc batteries of Examples 1 to 4 and Comparative Example 1 in a high temperature environment were evaluated. A specific evaluation method is shown below, and the results are shown in Table 1.

A test was performed in which the following operation was taken as one cycle: in an ambient temperature of 70° C., after the nickel-zinc battery was charged at 105.7 mA (0.33C) and a constant voltage of 1.88 V until the current value was damped to 16 mA (0.05C), the nickel-zinc battery was discharged at a constant current of 105.7 mA (0.33C) until the battery voltage reached 1.1 V. The number of cycles in which the discharge capacity was decreased to 70% when the discharge capacity at the first cycle was taken as 100% was regarded as cycle characteristics. The number of cycles of the nickel-zinc battery in each of Examples and Comparative Example is shown in Table 1.

Note that, the above-described “C” is a relative expression of the magnitude of the current when the rated capacity is discharged at a constant current from a fully charged state. The above-described “C” means “discharge current value (A)/battery capacity (Ah)”. For example, the current at which the rated capacity can be discharged in 1 hour is defined as “1C”, and the current at which the rated capacity can be discharged in 2 hours is defined as “0.5C”.

### <Evaluation of Output Characteristics>

As the output characteristics of the nickel-zinc batteries of Examples 1 to 4 and Comparative Example 1 in a low temperature environment, the direct-current resistance (DCR) was evaluated. A specific evaluation method is shown below, and the results are shown in Table 1.

For the nickel-zinc batteries of Examples 1 to 4 and Comparative Example 1, after charging was performed at a constant voltage of 1.9 V (charging was terminated when the current value was damped to 16 mA (0.05C)) in an environment of 25° C., discharging was performed at a constant current with current values of 160 mA (0.5C), 320 mA (1.0C), 640 mA (2.0C), and 960 mA (3.0C), respectively, for 1 second in an environment of −30° C., and the direct-current resistance (DCR) per total electrode area was calculated by the equation below. After discharging at a constant current, charging was performed at a constant current of 1C (current value of 320 mA) in an environment of −30° C. so that “the discharge capacity was equal to the charge capacity”.

$$DC R = \{ ( {Δ V}_{0.5 C} - V ) ( {I}_{0.5 C} - I ) + ( {Δ V}_{1. C} - V ) ( {I}_{1. C} - I ) + ( {Δ V}_{2. C} - V ) ( {I}_{2. C} - I ) + ( {Δ V}_{3. C} - V ) ( {I}_{3. C} - I ) \} / \{ {( {I}_{0.5 C} - I )}^{2} + {( {I}_{1. C} - I )}^{2} + {( {I}_{2. C} - I )}^{2} + {( {I}_{3. C} - I )}^{2} \} \cdot AE$$

In the above-described equation, I=(I_{0.5C}+I_{1.0C}+I_{2.0C}+I_{3.0C})/4 and V=Δ_{0.5C}+ΔV_{1.0C}+ΔV_{2.0C}+ΔV_{3.0C})/4 are satisfied, I_{0.5C}, I_{1.0C}, I_{2.0C}, and I_{3.0C} each represent discharge current values corresponding to discharge rates of 0.5C, 1.0C, 2.0C, and 3.0C, respectively, and ΔV_{0.5C}, ΔV_{1.0C}, ΔV_{2.0C}, and ΔV_{3.0C} each represent a voltage change after 1 second at each discharge current value. AE indicates the total electrode area. The values of the DCR obtained by the above method are shown in Table 1.

TABLE 1

| | Electrolytic | | |
|---|---|---|---|
| | solution | Cycle | Output |
| | Compound | characteristics | characteristics |
| | containing Lewis | Number of cycles | DCR |
| | acid | (time) | (Ω · cm²) |
| Example 1 | Boric acid | 150 | 9.2 |
| Example 2 | Sodium borate | 155 | 8.3 |
| Example 3 | Titanium lactate | 140 | 9.6 |
| Example 4 | Titanium | 143 | 10.2 |
| | triethanolaminate | | |
| Comparative | — | 90 | 12.9 |
| Example 1 | | | |

As shown in Table 1, the nickel-zinc batteries of Examples 1 to 4 have a larger number of cycles at 70° C. and a smaller value of DCR at −30° C. than the nickel-zinc battery of Comparative Example 1. That is, it can be said that in the nickel-zinc batteries of Examples 1 to 4, improvement in cycle characteristics in a high temperature environment and improvement in output characteristics in a low temperature environment are both achieved, as compared with the nickel-zinc battery of Comparative Example 1.

1. A zinc battery comprising a positive electrode, a negative electrode, and an electrolytic solution,
wherein the negative electrode has a negative electrode current collector and a negative electrode material supported by the negative electrode current collector,
the negative electrode material contains a negative electrode active material and a water-soluble polymer, and
the electrolytic solution contains a Lewis acid.

2. The zinc battery according to claim 1, wherein the Lewis acid includes a boric acid ion.

3. The zinc battery according to claim 1, wherein the Lewis acid includes a polyvalent metal ion.

4. The zinc battery according to claim 3, wherein the polyvalent metal ion includes at least one selected from the group consisting of an aluminum ion, a magnesium ion, a titanium ion, a chromium ion, a manganese ion, an iron ion, a cobalt ion, a nickel ion, a cadmium ion, a lead ion, a calcium ion, and a zirconium ion.

5. The zinc battery according to claim 1, wherein the water-soluble polymer includes at least one selected from the group consisting of a polyvinyl-based polymer, a poly(meth)acrylic polymer, and a polysaccharide.

6. The zinc battery according to claim 5, wherein the water-soluble polymer includes a polyvinyl alcohol.

7. The zinc battery according to claim 1, wherein the electrolytic solution contains boric acid.

8. The zinc battery according to claim 1, wherein the electrolytic solution contains sodium borate.

9. The zinc battery according to claim 2, wherein the electrolytic solution contains a compound containing the boric acid ion, and
a content of the compound containing the boric acid ion is 0.05 to 30% by mass based on a total mass of the electrolytic solution.

10. The zinc battery according to claim 1, wherein the water-soluble polymer includes at least one selected from the group consisting of a polyvinyl-based polymer and a poly(meth)acrylic polymer.

11. The zinc battery according to claim 6, wherein a content of the water-soluble polymer is 0.05 to 20% by mass based on a total mass of the negative electrode material.

12. The zinc battery according to claim 1, wherein the negative electrode material further contains an electrically conductive agent, and
a content of the electrically conductive agent is 1 to 50% by mass based on a total mass of the negative electrode material.
